(19) United States
(12) Patent Application Publication
(10) Pub. No.: US 2006/0288138 A1
(43) Pub. Date: Dec. 21, 2006

(54) Apparatus for universal bundled connecting bus between computers and peripherals

(76) Inventors: Oliver Keren Ban, Austin, TX (US); William Bornstein, Stormville, NY (US); Marie Meliksetian, Danbury, CT (US); Anthony Cappa Spielberg, Austin, TX (US)

Correspondence Address: VAN LEEUWEN & VAN LEEUWEN, P.O. BOX 90609, AUSTIN, TX, 78709-0609, US

(21) Appl. No.: 11/157,450

(22) Filed: Jun. 21, 2005

(51) Int. Cl. G06F 13/38

(52) U.S. Cl. 710/62

(57) ABSTRACT

An apparatus for a universal bundled connecting bus between computers and peripherals is presented. A bundled cable system includes a plurality of roller mechanisms for providing adjustable cables that connect peripheral devices to a computer. In one embodiment, the bundled cable system includes a separate internal cable for each communication link. Each of the internal cables includes a roller mechanism on each end that provides an adjustable cable for a user to vary in length in order to adequately connect peripheral devices to a computer. In another embodiment, the bundled cable system includes a single roller mechanism for each communication link. In this embodiment, each roller mechanism includes two adjustable cables that are extendible out from the roller mechanism, whereby one of the adjustable cables is extended and coupled to a peripheral device and the other adjustable cable is extended and coupled to a computing device.

### BACKGROUND OF THE INVENTION

1. Technical Field

The present invention relates in general to an apparatus for a universal bundled connecting bus between computers and peripherals. More particularly, the present invention relates to a bundled cable system that includes a plurality of roller mechanisms for providing adjustable cables that connect peripheral devices to a computer.

2. Description of the Related Art

A user's typical computer system environment includes a computer and peripheral devices, such as printers, DVD writers, and digital/audio equipment. Each peripheral device establishes a communication link to the computer using a particular interface cable (e.g., USB cable, Firewire cable, Ethernet cable, etc.).

A challenge found with existing art is that a user's computer system may include many peripheral devices and, therefore, require many interface cables. These cables typically become entangled during installation and/or while moving one of the peripheral devices, which creates an unsightly work environment.

In addition to the unsightliness, the tangled cables create operational problems as well, such as when a user wishes to troubleshoot a device or remove a device. This problem increases when more than one cable is the same cable type. For example, a computer system may include three peripheral devices that each use a USB cable to connect to a computer. In this example, if the user wishes to troubleshoot one of the devices and determine whether it is connected properly to the computer, the user has to trace the device's corresponding cable back to the computer and identify which computer port the corresponding cable is connected. Since the corresponding cable is entangled with similar cable types, tracing the corresponding cable is a difficult task.

In addition, when a user moves a peripheral device, cables attached to other peripheral devices may become loose due to the cable entanglement. For example, when the user moves a peripheral device, the moving causes the device's corresponding cable to pull on the other cables, which may cause the other cables to disconnect from their respective devices.

What is needed, therefore, is an apparatus that alleviates the unsightliness and operational problems of using separate cables for each peripheral device that connects to a computer.

### SUMMARY

It has been discovered that the aforementioned challenges are resolved using a bundled cable system that includes a plurality of roller mechanisms to provide adjustable cables for connecting peripheral devices to a computer.

In one embodiment, the bundled cable system includes a separate internal cable for each communication link. Each of the internal cables includes a roller mechanism on each end that provides an adjustable cable for a user to vary in length in order to adequately connect peripheral devices to a computer.

In another embodiment, the bundled cable system may include a single roller mechanism for each communication link. In this embodiment, each roller mechanism includes two adjustable cables that are extendible out from the roller mechanism, whereby one of the adjustable cables is extended and coupled to a peripheral device and the other adjustable cable is extended and coupled to a computer.

The bundled cable system may include similar communication links or different communication links. For example, one bundled cable system may include four USB communication links, while another bundled cable system may include a USB communication link, a Firewire communication link, and an audio communication link. In either case, the adjustable cables that protrude from the bundled cable system are identifiable such that a user may adequately connect peripheral devices to a computer.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a desktop computer connected to a plurality of peripheral devices using separate cables for each peripheral communication link;

FIG. 2 is a diagram showing a desktop computer connected to a plurality of peripheral devices using a bundled cable system;

FIG. 3 is a diagram showing a bundled cable system that includes two roller mechanisms for each communication link;

FIG. 4 is a diagram showing a bundled cable system that includes a single roller mechanism for each communication link;

FIG. 5 is an example of a bundled cable system that includes three similar communication link types; and

FIG. 6 is an example of a bundled cable system that includes three different communication link types.

### DETAILED DESCRIPTION

The following is intended to provide a detailed description of an example of the invention and should not be taken to be limiting of the invention itself. Rather, any number of variations may fall within the scope of the invention, which is defined in the claims following the description.

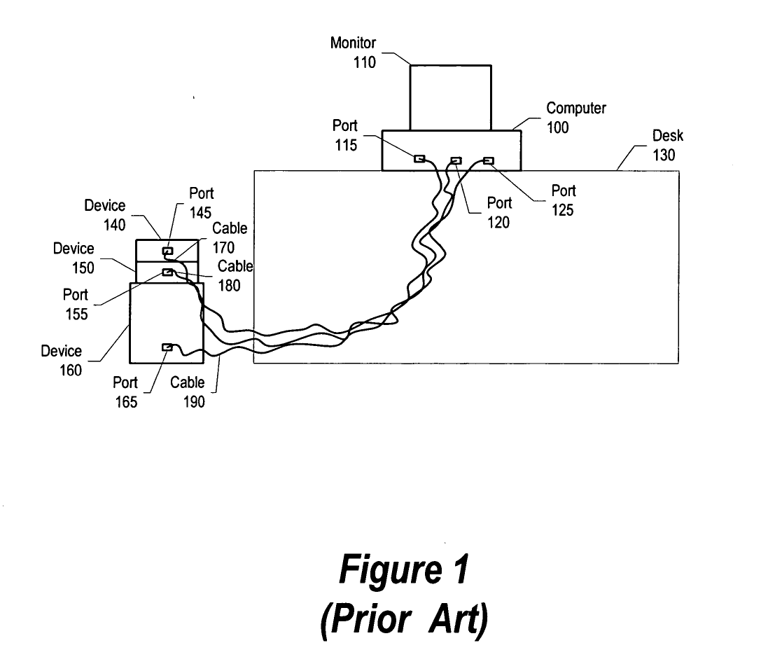

FIG. 1 is a diagram showing a desktop computer connected to a plurality of peripheral devices using separate cables for each peripheral communication link. In a typical user environment, a user places computer 100 and monitor 110 on desk 130, and places peripherals, such as devices 140 through 160, in proximity to computer 100 in or to connect the peripherals to computer 100 using an appropriate cable.

Without using the invention described herein, computer 100 communicates with devices 140 through 160 using separate, individual cables 170 through 190, respectively. Device 140 may be a printer that includes a USB port (port 145) and communicates with computer 100 using a USB cable (cable 170). Device 150 may be a digital video device that includes a Firewire port (port 155) and communicates with computer 100 using a Firewire cable (cable 180). Finally, device 160 may be a surround sound system that includes an audio port (port 165) and communicates with computer 100 using an audio cable (cable 190).

As can be seen, cables 170 through 190 may become tangled together during installation and/or while moving devices, which creates an unsightly work environment. In addition to the unsightliness, the tangled cables create operational problems, such as when a user wishes to troubleshoot a device or remove a device. This problem increases when more than one cable is the same cable type. For example, device 140, 150, and 160 may be devices that each use a USB cable to connect to computer 100. In this example, if the user wishes to troubleshoot device 140 and determine whether it is connected properly to computer 100, the user has to trace cable 170 back to computer 100 and identify which port (port 115, 120, or 125) cable 170 is connected. Since cable 170 is entwined with cables 180 and 190, tracing cable 170 is a difficult task.

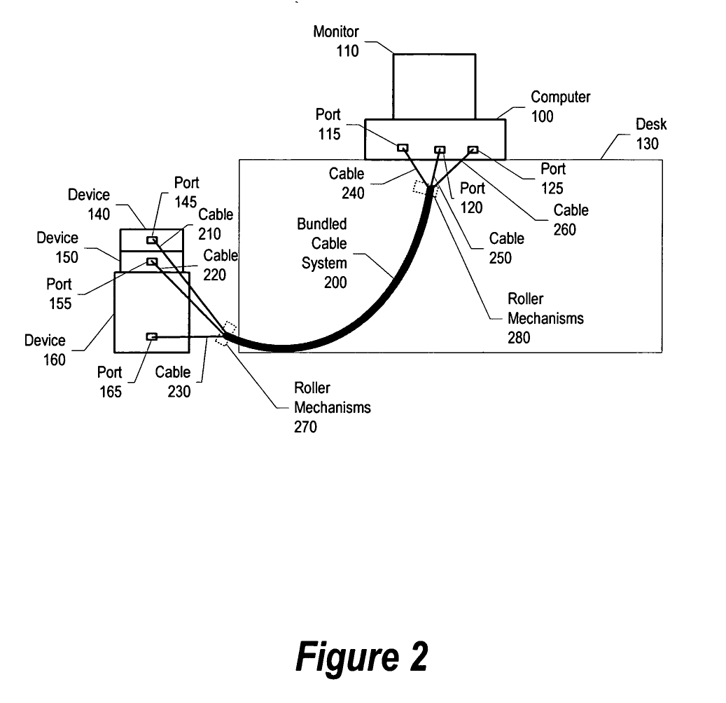

In addition, when a user moves a device, cables attached to other devices may become loose because of the cable entanglement. For example, if the user moves device 140 on top of desk 130, the possibility exists for cable 180 to disconnect from device 150 and cable 190 to disconnect from device 160. Therefore, a bundled cable system is described herein that alleviates the unsightliness and operational problems of the computer system shown in FIG. 1 (see FIGS. 2 through 6 for further details regarding the bundled cable system).

FIG. 2 is a diagram showing a desktop computer connected to a plurality of peripheral devices using a bundled cable system. FIG. 2 is similar to FIG. 1 with the exception that computer 100 is connected to peripheral devices 140 through 160 using bundled cable system 200.

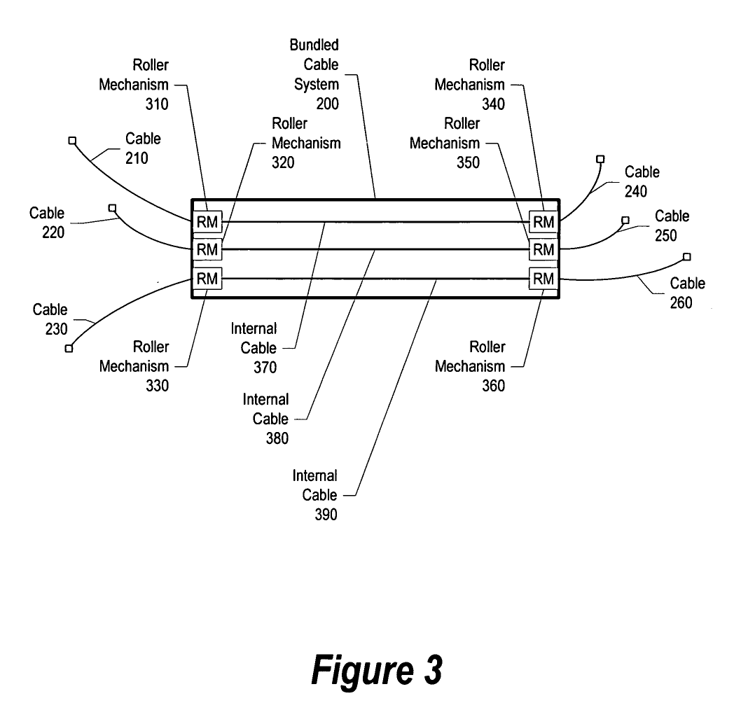

As can be seen, using bundled cable system 200 to connect peripheral devices to a desktop computer creates a much cleaner work environment than using individual cables, such as the example shown in FIG. 1. In one embodiment, bundled cable system 200 includes a separate internal cable for each communication link. Therefore, since the example shown in FIG. 2 shows that three devices are connected to computer 100, three separate internal cables are included in bundled cable system 200 (see FIG. 3 and corresponding text for further details regarding internal cables).

Each of the internal cables includes a roller mechanism on each end (roller mechanisms 270 and 280) that provides an adjustable cable for a user to vary in length in order to adequately connect devices 140 through 160 to computer 100. Using the example shown in FIG. 2, roller mechanisms 270 include three roller mechanisms, whereby a first roller mechanism provides adjustable cable 210 that is extended to connect to device 140 through port 145. The second roller mechanism provides adjustable cable 220 that is extended to connect to device 150 through port 155. And the third roller mechanism provides adjustable cable 230 that is extended to connect to device 160 through port 165.

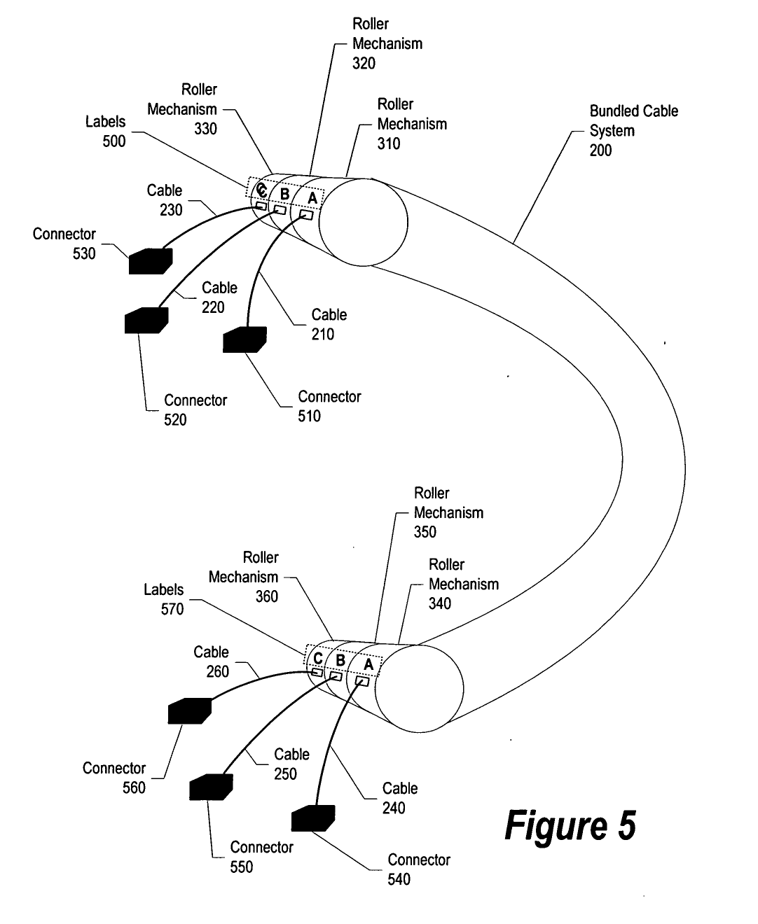

Continuing with the above example, on the other side of bundled cable system 200, roller mechanisms 280 includes three corresponding roller mechanisms. The first roller mechanism provides adjustable cable 240 that is extended to connect to computer 100's port 115. The second roller mechanism provides cable 250 that is extended to connect to computer 100's port 120. And the third roller mechanism provides cable 260 that is extended to connect to computer 100's port 125. Roller mechanisms 270 and 280 may be labeled for a user to identify which adjustable cables on one end of bundled cable system 200 correspond with the adjusted cables on the other end of bundled cable system 200 (see FIG. 5 and corresponding text for further details regarding roller mechanism labeling).

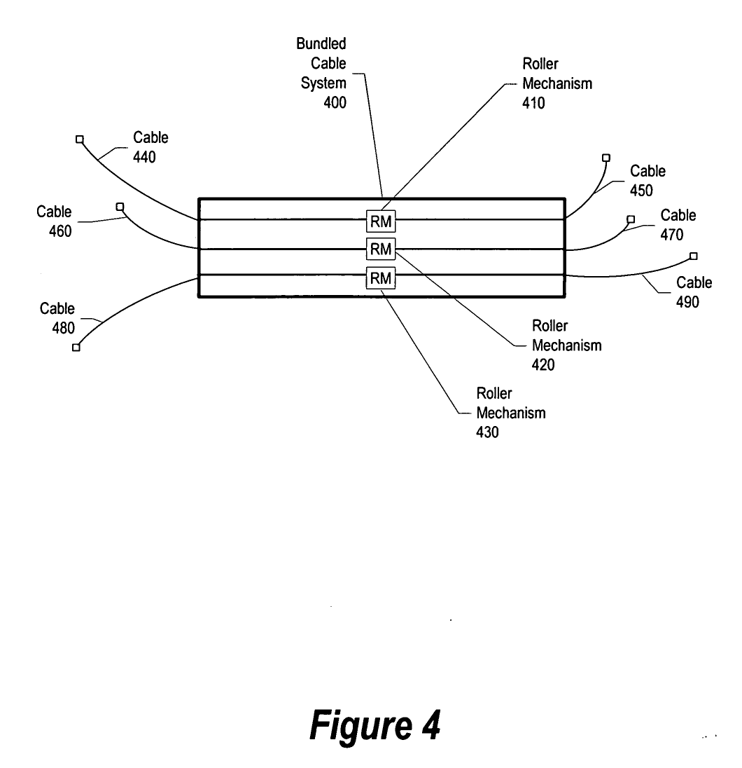

In one embodiment, bundled cable system 200 may include a single roller mechanism for each communication link. In this embodiment, each roller mechanism includes two adjustable cables that are extendible out from the roller mechanism, whereby one of the adjustable cables is extended and coupled to a peripheral device and the other adjustable cable is extended and coupled to a computer (see FIG. 4 and corresponding text for further details regarding single roller mechanism configurations).

FIG. 3 is a diagram showing a bundled cable system that includes two roller mechanisms for each communication link. Bundled cable system 200 is the same as that shown in FIG. 2, and is capable of connecting three peripheral devices to a computer. As one skilled in the art can appreciate, bundled cable system 200 may be fabricated to connect more or less peripheral devices to a computer than what is shown in FIGS. 2 and 3.

Bundled cable system 200 includes internal cables 370, 380, and 390, which are bundled using a material for insulating them from external environments, such as plastic wrapping. These internal cables are fixed length cables and designed per industry standards. Each of the internal cables provides a connection to roller mechanisms that are located at opposite ends of bundled cable system 200. As can be seen, internal cable 370 couples roller mechanism 310 to roller mechanism 340, internal cable 380 couples roller mechanism 320 to roller mechanism 350, and internal cable 390 couples roller mechanism 330 to roller mechanism 360.

Each of the roller mechanisms includes an adjustable cable that a user changes in length in order to connect peripheral devices to a computer. For example, a user may connect adjustable cables 210 through 230 to peripheral devices, and connect adjustable cables 240 through 260 to the computer system.

In one embodiment, a bundled cable system may be fabricated that includes one roller mechanism per communication link that includes two adjustable cables. In this embodiment, one of the adjustable cables connects to a peripheral device and the other adjustable cable connects to a computer (see FIG. 4 and corresponding text for further details regarding a bundled cable system with a single roller mechanism corresponding to each communication link).

FIG. 4 is a diagram showing a bundled cable system that includes a single roller mechanism for each communication link. Bundled cable system 400 includes three communication links, whereby the first communication link passes through roller mechanism 410, the second communication link passes through roller mechanism 420, and the third communication link passes through roller mechanism 430.

Each of roller mechanisms 410 through 430 includes two adjustable cables that a user may vary in length. Roller mechanism 410 includes adjustable cables 440 and 450, whereby a user may extend adjustable cable 440 out from bundled cable system 400 to a length that is appropriate to couple to a first peripheral device. In turn, the user may extend adjustable cable 450 out from bundled cable system 400 to a length that is appropriate to couple to a computer, completing the communication link between the first peripheral device and the computer.

Roller mechanism 420 includes adjustable cables 460 and 470, whereby a user may extend adjustable cable 460 out from bundled cable system 400 to a length that is appropriate to couple to a second peripheral device. In turn, the user may extend adjustable cable 470 out from bundled cable system 400 to a length that is appropriate to couple to a computer, completing the communication link between the second peripheral device and the computer.

Finally, roller mechanism 430 includes adjustable cables 480 and 490, whereby a user may extend adjustable cable 480 out from bundled cable system 400 to a length that is appropriate to couple to a third peripheral device. In turn, the user may extend adjustable cable 490 out from bundled cable system 400 to a length that is appropriate to couple to a computer, completing the communication link between the third peripheral device and the computer.

FIG. 5 is an example of a bundled cable system that includes three similar communication link types. Bundled cable system 200 is the same as that shown in FIG. 2, and includes three communication links, whereby each of the communication links is similar. For example, connectors 510, 520, and 530 may each be a USB connector that connects to a peripheral device, and connectors 540, 550, and 560 may each be a USB connector that connects to a computer desktop port. When bundled cable system 200 includes similar communication link types, a user uses roller mechanism labels 500 and 570 to identify adjustable cables that correspond to each other in order to appropriately connect peripheral devices to a computer.

In one embodiment, the adjustable cables may be color-coded for a user to properly connect peripheral devices to a computer. For example, three adjustable cables may be colored red, white, and blue, respectively, and their corresponding adjustable cables on the other end of bundled cable system 200 may be colored the same color.

Bundled cable system 200 includes roller mechanisms 310 through 330, and 340 through 360. As can be seen, roller mechanism 310 and 340 are both labeled “A.” Therefore, a user may connect a peripheral device to a computer by connecting cable 210's connector 510 to the peripheral device and connecting cable 240's connector 540 to the computer.

Likewise, using roller mechanisms 320 and 350 (labeled “B”), a user may connect a peripheral device to a computer by connecting cable 220's connector 520 to the peripheral device and connecting cable 250's connector 550 to the computer. Finally, using roller mechanisms 330 and 360 (labeled “C”), a user may connect a peripheral device to a computer by connecting cable 230's connector 530 to the peripheral device and connecting cable 260's connector 560 to the computer.

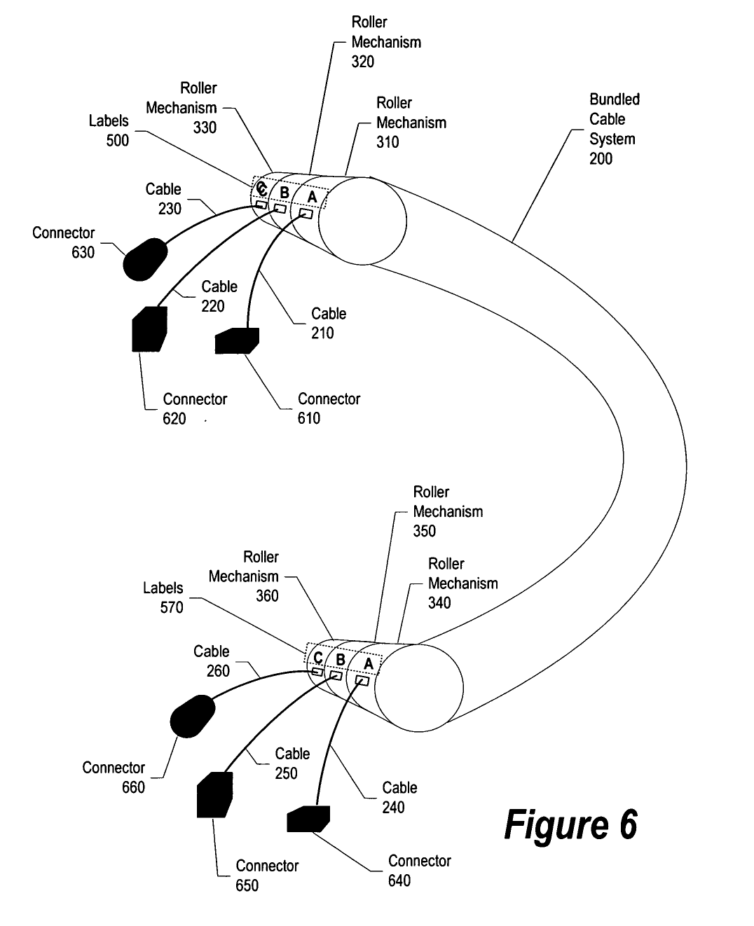

FIG. 6 is an example of a bundled cable system that includes three different communication link types. FIG. 6 is similar to FIG. 5 with the exception that bundled cable system 200 includes three different types of communication links. For example, bundled cable system 200 may include a USB communication link, a Firewire communication link, and an audio communication link.

When using a bundled cable system that includes different communication link types, a user may not need to use labels 500 and 570 as discussed in FIG. 5 since the connectors are different. However, many connectors appear similar even though they are used for different communication link types and, therefore, a user may choose to reference labels 500 and 570 when connecting peripheral devices to a computer.

Bundled cable system 200 includes roller mechanisms 310 through 330, and 340 through 360. As can be seen, roller mechanism 310 and 340 are both labeled “A” and correspond to a communication link type that uses connectors 610 and 640. Therefore, a user may connect a peripheral device to a computer by connecting cable 210's connector 610 to the peripheral device and connecting cable 240's connector 640 to the computer.

Likewise, roller mechanisms 320 and 350 (labeled “B”) correspond to a communication link type that uses connectors 620 and 650. Therefore, a user may connect a peripheral device to a computer by connecting cable 220's connector 620 to the peripheral device and connecting cable 250's connector 650 to the computer. Finally, roller mechanisms 330 and 360 (labeled “C”) correspond to a communication link type that specifies connectors 630 and 660. Therefore, a user may connect a peripheral device to a computer by connecting cable 230's connector 630 to the peripheral device and connecting cable 260's connector 660 to the computer.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. An apparatus comprising:
a plurality of communication links, wherein each of the plurality of communication links comprises:
an internal cable that includes a first end and a second end;
a first roller mechanism coupled to the first end of the internal cable, the first roller mechanism including a first adjustable cable; and
a second roller mechanism coupled to the second end of the internal cable, the second roller mechanism including a second adjustable cable; and
material for bundling each of the internal cables, each of the first roller mechanisms, and each of the second roller mechanisms to form a bundled cable system.

2. The apparatus of claim 1 wherein one of the plurality of communication links corresponds to a first communication link type and another one of the plurality of communication links corresponds to a second communication link type that is different than the first communication link type.

3. The apparatus of claim 2 wherein each of the plurality of communication links further comprises:
a first connector coupled to the first adjustable cable;
a second connector coupled to the second adjustable cable; and
wherein the first connector and the second connector corresponding to the first communication link type are different than the first connector and the second connector corresponding to the second communication link type.

4. The apparatus of claim 2 wherein the first adjustable cable and the second adjustable cable corresponding to the first communication link type are a different color than the first adjustable cable and the second adjustable cable corresponding to the second communication link type.

5. The apparatus of claim 1 wherein the material is a plastic material that insulates the plurality of communication links from an external environment.

6. The apparatus of claim 1 wherein each of the first adjustable cables is adapted to connect to a peripheral device and each of the second adjustable cables is adapted to connect to a computer port.

7. The apparatus of claim 1 wherein each of the plurality of communication links includes a label on their corresponding first roller mechanism and their corresponding second roller mechanism, the label distinguishing each of the plurality of communication links from the other plurality of communication links.

8. The apparatus of claim 1 wherein the material is flexible.

9. The apparatus of claim 1 wherein each of the first adjustable cables are adjustable to different lengths and each of the second adjustable cables are adjustable to different lengths.

10. An apparatus comprising:
a plurality of communication links, wherein each of the plurality of communication links comprises:
a roller mechanism, the roller mechanism including a first adjustable cable and a second adjustable cable; and
material for bundling each of the roller mechanisms, each of the first adjustable cables, and each of the second adjustable cables to form a bundled cable system.

11. The apparatus of claim 10 wherein one of the plurality of communication links corresponds to a first communication link type and another one of the plurality of communication links corresponds to a second communication link type that is different than the first communication link type.

12. The apparatus of claim 11 wherein each of the plurality of communication links further comprises:
a first connector coupled to the first adjustable cable;
a second connector coupled to the second adjustable cable; and
wherein the first connector and the second connector corresponding to the first communication link type are different than the first connector and the second connector corresponding to the second communication link type.

13. The apparatus of claim 11 wherein the first adjustable cable and the second adjustable cable corresponding to the first communication link type are a different color than the first adjustable cable and the second adjustable cable corresponding to the second communication link type.

14. The apparatus of claim 10 wherein the material is a plastic material that insulates the plurality of communication links from an external environment.

15. The apparatus of claim 10 wherein each of the first adjustable cables is adapted to connect to a peripheral device and each of the second adjustable cables is adapted to connect to a computer port.

16. The apparatus of claim 10 wherein the material is flexible.

17. The apparatus of claim 10 wherein each of the first adjustable cables are adjustable to different lengths and each of the second adjustable cables are adjustable to different lengths.

18. An apparatus comprising:
a plurality of communication links, wherein each of the plurality of communication links comprises:
an internal cable that includes a first end and a second end;
a first roller mechanism coupled to the first end of the internal cable that includes a first adjustable cable, the first adjustable cable including a first connector that is adapted to connect to a peripheral device; and
a second roller mechanism coupled to the second end of the internal cable that includes a second adjustable cable, the second adjustable cable including a second connector that is adapted to connect to a computer port; and
flexible material for bundling each of the internal cables, each of the first roller mechanisms, and each of the second roller mechanisms to form a bundled cable system.

19. The apparatus of claim 18 wherein one of the plurality of communication links corresponds to a first communication link type and another one of the plurality of communication links corresponds to a second communication link type that is different than the first communication link type.

20. The apparatus of claim 18 wherein each of the plurality of communication links includes a label on their corresponding first roller mechanism and their corresponding second roller mechanism, the label distinguishing each of the plurality of communication links from the other plurality of communication links.
